(19) United States
(12) Patent Application Publication
(10) Pub. No.: US 2026/0210907 A1
(43) Pub. Date: Jul. 23, 2026

(54) CAPILLARY ELECTROPHORESIS DEVICE

(71) Applicant: HITACHI HIGH-TECH CORPORATION, Tokyo (JP)

(72) Inventors: Ryo IMAI, Tokyo (JP); Takashi ANAZAWA, Tokyo (JP); Motohiro YAMAZAKI, Tokyo (JP)

(21) Appl. No.: 19/137,676

(22) PCT Filed: Feb. 22, 2024
(86) PCT No.: PCT/JP2024/006416

§ 371 Date: Jun. 11, 2025

(30) Foreign Application Priority Data
Mar. 24, 2023 (JP) 2023-047898

(51) Int. Cl. G01N 27/447

(52) U.S. Cl. CPC G01N 27/44721; G01N 27/44782

(57) ABSTRACT

The present disclosure provides a capillary electrophoresis device including a light source, a first irradiation fiber configured to guide light from the light source, a detector configured to detect light from a capillary, and a first detection fiber configured to guide light to the detector, in order to make a light detection optical system less susceptible to an external environment. A capillary cartridge including a capillary, a second irradiation fiber, and a second detection fiber is attached to the capillary electrophoresis device by connecting the first irradiation fiber and the second irradiation fiber and connecting the first detection fiber and the second detection fiber. In the capillary cartridge, the second irradiation fiber and the second detection fiber are fixed such that their optical axes intersect each other in the lumen of the capillary.

### TECHNICAL FIELD

The present disclosure relates to a capillary electrophoresis device, particularly to a device that optically detects an analyte in a capillary.

### BACKGROUND ART

In the analysis using capillary electrophoresis, a sample to be analyzed is injected into a capillary filled with a separation medium, and a voltage is applied to both ends to perform separation by a difference in mobility of the analysis target. There is a plurality of means for measuring the separated sample, and there are a method of detecting fluorescence emitted from the sample, a method of detecting light absorption by the sample, and the like.

For example, there is a method in which DNA labeled with a fluorescent dye is electrophoresed in a capillary filled with a polymer to separate for each chain length. A detection site provided on the capillary is irradiated with excitation light, and generated fluorescence is detected. The DNA molecules in the sample move through the capillary and pass through the detection site at different times depending on the chain length. As a result, the chain length distribution of the DNA molecules in the sample is acquired as a fluorescence intensity waveform.

A capillary electrophoresis device, an inner diameter of a capillary for separating a sample is generally about several tens um. In order to increase the detection sensitivity, it is desirable to irradiate the capillary inner diameter through which the sample passes with fluorescence excitation light without loss as much as possible. Therefore, it is desirable that the excitation light is condensed to the same extent as or smaller than the inner diameter of the capillary and is applied to the inner diameter of the capillary. At this time, the positions of the capillary and the condensed excitation light need to be adjusted with positional accuracy equal to or higher than the size of the capillary inner diameter. In particular, when a configuration is adopted in which a plurality of capillaries is arranged in a line and excitation light is incident from the side surface thereof to excite all the capillaries at once, the excitation light needs to pass through all the capillary inner diameters without loss as much as possible. Therefore, the demand for position accuracy becomes more severe, and the position error needs to be about 10 μm or less.

In a case where there is a plurality of types of fluorescent dyes to be labeled on the measurement target, the generated fluorescence is introduced into a spectroscopic optical system, and measured by an imaging element after the wavelength is separated. As an example, spectroscopy is performed by a grating. In this case, when the position of the light emission point in the capillary changes in the £ wavelength separation direction, the wavelength of fluorescence appears to be shifted on a detector. Since the type of the fluorescent dye that has emitted light is discriminated from the spectrum shape of the measured light, when the fluorescence wavelength shifts, the discrimination accuracy of the fluorescent dye decreases. A decrease in dye discrimination accuracy may lead to, for example, erroneous detection of a DNA strand that does not originally exist in DNA analysis, which is undesirable.

From the above, the positional relationship between the excitation light irradiation optical system, the capillary, and the detection optical system needs to be accurately adjusted with an error of about several tens μm or less. In addition, it is not desirable that the detection performance of the device changes, and it is desirable that the positional relationship is maintained even when the device is used for a long period of time or the device is moved. On the other hand, in capillary electrophoresis, the capillary is a consumable item, and deteriorates when measurement is performed a certain number of times, so that replacement is required. Therefore, it is necessary to maintain the above positional accuracy even if the capillary is replaced. From the viewpoint of user convenience, it is desirable that the capillary replacement can be easily performed.

### CITATION LIST

### Patent Literature

PTL 1: JP 8-304339 A

PTL 2: JP 2004-532384 A

PTL 3: US 2021/0003530 A1

### Non Patent Literature

NPL 1: H. Zhai et al., “A simple and compact fluorescence detection system for capillary electrophoresis and its application to food analysis,” Electrophoresis, 36, 2509 (2015).

### SUMMARY OF INVENTION

### Technical Problem

A capillary used for electrophoresis, an optical system that irradiates the capillary with light, and an optical system that detects light are usually incorporated and fixed in an electrophoresis device. However, the position of each component and the optical element inside the component may change due to vibration or impact transmitted from the outside, such as when the device is moved. In addition, even when vibration or impact is not applied due to expansion or contraction of each member due to an external environment, particularly a temperature change, a change in the position of the optical element may occur.

Replacement of the capillary may also cause a change in position. The position of the capillary may change from that before replacement due to tolerance of the outer diameter of the capillary to be installed, an error in fixing position generated in a capillary fixing mechanism, and the like. When the number of capillaries is plural, the capillary array is often supplied to the user in a state where the capillaries are fixed on a fixing member, but the position of the capillary array may change due to an error in assembly of the fixing member and a main body.

There has been proposed a method of reducing the occurrence and influence of the position error as described above by assembling a fiber optical system to an electrophoresis channel. For example, PTL 1 discloses a method in which an optical fiber for performing excitation and detection is installed on a channel chip, and a capillary that is a consumable item is attached to the channel chip, so that the relative positional relationship of the detection optical system does not change even if the capillary is replaced. However, in this method, there is a problem that separation performance of electrophoresis is adversely affected when an event such as generation of a gap between channels at a joint between a capillary and a channel chip or displacement of central axes of the capillary and the channel chip occurs. Therefore, it is desirable that the electrophoresed sample is detected at a detection point provided in a part of the capillary. In addition, in the method of PTL 1, when a plurality of capillaries is mounted, it is necessary to mount a plurality of disclosed structures, thereby the device becomes large in size. Further, the excitation light has to be branched by the number of detection fibers, so that there is a problem that the power of the excitation light is reduced and the detection performance is deteriorated.

PTL 2 describes a method of reducing alignment accuracy required at the time of capillary replacement by providing a cartridge in which optical components such as an optical fiber and a lens are assembled to a capillary. In the configuration disclosed in PTL 2, a detection fiber array including a light source such as an LED and a lens is connected to a capillary cartridge incorporating an irradiation fiber. In this configuration, the relative positional relationship between the capillary and the irradiation fiber hardly changes. However, the position adjustment accuracy of the capillary and the detection fiber array, and the light source and the irradiation fiber at the time of cartridge replacement depends on the accuracy of the detachable mechanical fixing mechanism. Considering that the capillary cartridge is a consumable item, the mechanical fixing mechanism needs to be inexpensive. This mechanical fixing mechanism needs to be robust against external vibration and impact, and needs to always keep the positional relationship of each component constant. PTL 2 does not disclose that the described fixing mechanism satisfies the above requirement.

NPL 1 describes a method of performing detection by fixing a capillary and irradiation and detection fibers on a plate having a groove formed of polydimethylsiloxane. In this method, since the capillary and the optical element are fixed on the same base, positional displacement of the optical element due to vibration and impact hardly occurs. However, a method of capillary replacement is not described, and a method of adjusting the relative positional relationship between the capillary and the optical system at the time of capillary replacement is also not described. In addition, when the number of capillaries is plural, a problem similar to that in PTL 1 may occur.

In capillary electrophoresis, it is necessary to uniformly adjust the temperature of the capillary. As an example, when DNA is analyzed by capillary electrophoresis, the temperature of the capillary is kept at about 60° C. so that electrophoresis is performed in a state where DNA is denatured. In order to keep the separation ability of electrophoresis high and return the same measurement result every time for the same sample, it is necessary that the entire capillary has a uniform temperature and temperature fluctuation is small. This temperature adjustment mechanism also needs to achieve both temperature adjustment performance and ease of capillary replacement.

Regarding the temperature adjustment of the capillary, PTL 1 and PTL 2 each describe a capillary temperature adjustment method, but do not mention that the disclosed structure is particularly advantageous for temperature adjustment. NPL 1 does not describe temperature adjustment of the capillary.

### Solution to Problem

An example of a capillary electrophoresis device according to the present disclosure is an electrophoresis device including:
a light source;
a first irradiation fiber configured to guide light from the light source;
a detector configured to detect light from a capillary; and
a first detection fiber configured to guide light to the detector,
in which a capillary cartridge including the capillary, a second irradiation fiber, and a second detection fiber is attached to the electrophoresis device by connecting the first irradiation fiber and the second irradiation fiber, and connecting the first detection fiber and the second detection fiber, and in the capillary cartridge, the second irradiation fiber and the second detection fiber are fixed such that optical axes of the second irradiation fiber and the second detection fiber intersect each other in an inner cavity of the capillary.

### Advantageous Effects of Invention

According to the capillary electrophoresis device of the present disclosure, it is possible to make the light detection optical system in the capillary electrophoresis device less susceptible to change of the external environment, impact, and vibration.

Since the main body and the optical system of the capillary cartridge can be connected by the connection of the optical fiber, the capillary cartridge can be easily attached and detached.

In the configuration of the present disclosure, a detection window of the capillary can be isolated from the external environment. Therefore, the temperature of the entire capillary including the measurement window can be accurately adjusted.

The configuration of the present disclosure can be extended even when the number of capillaries is plural. By adopting a configuration in which the excitation light is applied from the side surface of the capillary array, it is possible to prevent the reduction of the excitation light power due to the division of the excitation light from occurring even when the number of capillaries is large.

### BRIEF DESCRIPTION OF DRAWINGS

FIG. 1 is a configuration diagram of an electrophoresis device 100 according to a first embodiment of the present disclosure.

FIG. 2 is a diagram illustrating a flow of measurement by the electrophoresis device 100 according to the first embodiment of the present disclosure.

FIG. 3 illustrates a method of fixing capillaries 111 and a cartridge-side irradiation fiber 114 at a detection site 116.

FIG. 4 illustrates a method of fixing a cartridge-side detection fibers 115 at the detection site 116.

FIG. 5 illustrates a method of fixing the capillaries 111, the cartridge-side irradiation fiber 114, and the cartridge-side detection fibers 115 at the detection site 116.

FIG. 6 is a schematic view illustrating a connection portion of a capillary cartridge 110.

FIG. 7 is a schematic view illustrating a method of adjusting the temperature of the capillaries 111.

FIG. 8 is a configuration diagram of an electrophoresis device 800 according to a second embodiment of the present disclosure.

FIG. 9 is a structural diagram of the electrophoresis device 800 and a capillary cartridge 801 according to the second embodiment of the present disclosure.

FIG. 10 is a schematic view illustrating a method of fixing the detection site 116.

FIG. 11 is a diagram illustrating a structure of a detection site 116 according to a third embodiment of the present disclosure.

FIG. 12 is a diagram illustrating an arrangement of optical fibers in a case of performing both fluorescence measurement and absorbance measurement.

FIG. 13 is a diagram illustrating a structure of a fixing substrate 1301 according to a fourth embodiment of the present disclosure.

FIG. 14 is a diagram illustrating arrangement of capillaries 1401, an irradiation fiber 1402, and detection fibers 1403 with respect to the fixing substrate 1301.

FIG. 15 is a diagram illustrating a cause of occurrence of inter-capillary crosstalk.

FIG. 16 is a diagram illustrating an effect Of reducing inter-capillary crosstalk by the fixing substrate 1301.

### DESCRIPTION OF EMBODIMENTS

### First Embodiment

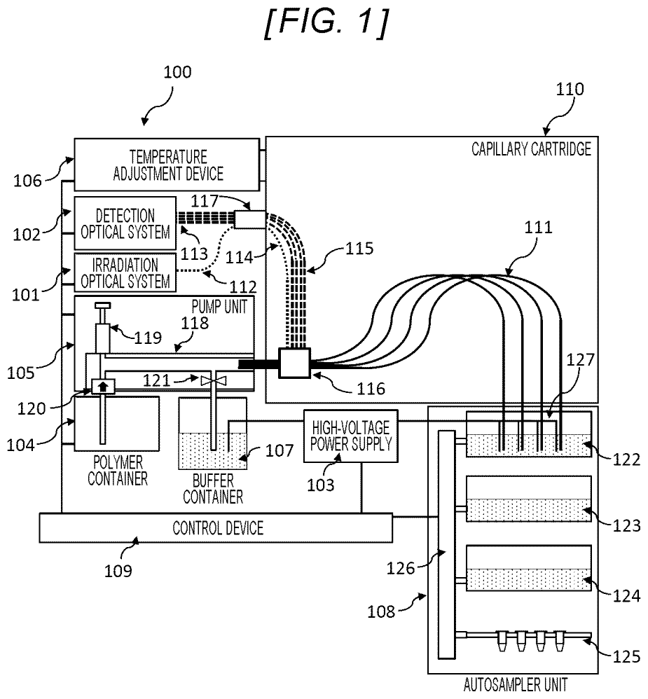

FIG. 1 is a configuration diagram of an electrophoresis device 100 according to a first embodiment of the present disclosure. The present embodiment illustrates an example of a case where fluorescence detection is adopted as a detection method. DNA is considered as a sample to be measured, but the sample is not limited thereto. The electrophoresis device 100 includes an irradiation optical system 101 that generates excitation light of fluorescence for fluorescence measurement, and a detection optical system 102 that detects fluorescence. In addition, the electrophoresis device 100 includes, as devices for performing electrophoresis, a high-voltage power supply 103, a polymer container 104 that holds a polymer as a separation medium, a pump unit 105 that causes the polymer to be filled, a temperature adjustment device 106 that adjusts the temperature of the capillary, a buffer container 107 that is electrically connected to both ends of the capillary and holds a buffer that applies the voltage of the high-voltage power supply to the capillary, and an autosampler unit 108. These components are controlled by a control device 109. A capillary cartridge 110, which is a consumable item, is connected to the electrophoresis device 100. The capillary cartridge includes capillaries 111 therein. The high-voltage power supply 103 applies a voltage to both ends of the capillaries 111 via the buffer.

The irradiation optical system 101 in the electrophoresis device 100 includes a body-side irradiation fiber 112 for guiding generated excitation light, and the detection optical system 102 includes body-side detection fibers 113 for guiding fluorescence. On the other hand, the capillary cartridge 110 includes a cartridge-side irradiation fiber 114 for guiding excitation light to the capillaries and cartridge-side detection fibers 115 for guiding fluorescence generated in the capillaries. The relative positions of the capillaries 111, the cartridge-side irradiation fiber 114, and the cartridge-side detection fibers 115 are adjusted and fixed at a detection site 116. The body-side irradiation fiber 112 and the cartridge-side irradiation fiber 114, and the body-side detection fibers 113 and the cartridge-side detection fibers 115 are connected by a fiber connector 117.

The pump unit 105 includes a channel block 118, a syringe 119, a check valve 120, and a valve 121. The check valve 120 is installed so that the fluid flows only in the direction from the polymer container 104 to the channel block 118. The autosampler unit 108 includes a buffer tray 122, a cleaning water tray 123, a waste liquid tray 124, a sample tray 125, and a stage 126 that controls the positions of these trays. An electrode 127 is provided near the sample injection ends of the capillaries 111. The ends of the capillaries 111 and the high-voltage power supply 103 are electrically connected when the buffer tray 122 and the sample tray 125 are installed near the injection ends.

Hereinafter, a mechanism in which fluorescence detection is performed by the electrophoresis device 100 of the present disclosure will be described. The excitation light generated in the irradiation optical system 101 is introduced into the body-side irradiation fiber 112, and is introduced into the cartridge-side irradiation fiber 114 by the fiber connector 117. The excitation light reaches the detection site 116 by the cartridge-side irradiation fiber 114 and is applied to the inner diameters of the capillaries 111. The fluorescences generated at the excitation light irradiation sites of the capillaries 111 are collected by the cartridge-side detection fibers 115 and delivered to the body-side detection fibers 113 by the fiber connector 117. Thereafter, the fluorescences are detected by the detection optical system 102 and converted into electric signals. This signal is recorded by the control device 109.

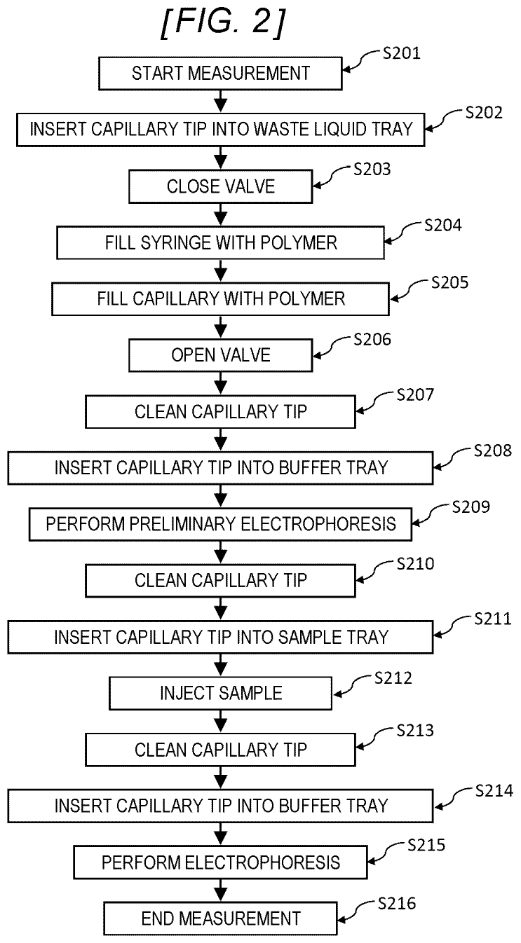

Hereinafter, a mechanism of analyzing a sample by electrophoresis in the electrophoresis device 100 of the present disclosure will be described. As an example, the electrophoresis analysis is performed in the order of polymer injection into the capillaries, pre-electrophoresis, sample injection, and sample electrophoresis. The operating steps of the device in the electrophoresis analysis are illustrated in FIG. 2.

When the measurement is started (S201), the capillaries 111 are initially filled with the polymer by the pump unit 105. First, the waste liquid tray 124 is installed at the ends of the capillaries 111 (S202), and the valve 121 is closed (S203). With the valve 121 closed, the syringe 119 is brought into a negative pressure, and the polymer from the polymer container 104 is filled in the syringe 119 (S204). Note that the inner diameters of the capillaries 111 are about several tens of μm and are sufficiently smaller than the channel diameter of the channel block 118, and the buffer does not flow from the capillaries 111 to the syringe 119 because the resistance is large. Next, the syringe 119 is pressurized and the capillaries 111 are filled with the polymer (S205). Thereafter, the valve 121 is opened, and the ends of the capillaries 111 are electrically connected to the high-voltage power supply 103 (S206).

After the capillaries are filled with the polymer, pre-electrophoresis is performed. The cleaning water tray 123 moves to the sample introduction ends of the capillaries 111 to clean the tip portions (S207). Next, the buffer tray 122 is placed at the sample introduction ends of the capillaries 111 (S208), a high voltage is applied for about several minutes by the high-voltage power supply 103, and preliminary electrophoresis is performed (S209). Impurity ions of the polymer filled in the capillaries are removed by pre-electrophoresis before sample injection.

After the pre-electrophoresis, the sample is injected into the capillaries 111. First, the cleaning water tray 123 moves to the sample introduction ends of the capillaries 111 to clean the tip portions (S210). Thereafter, the sample tray 125 is placed at the sample introduction ends of the capillaries 111 (S211), and the sample is electrically injected into the capillaries 111 by applying a short-time voltage of about several seconds to both ends of the capillaries 111 by a high-voltage power supply (S212). By this step, the sample is injected into only small regions of the ends of the capillaries 111. Next, the cleaning water tray 123 moves to the sample introduction ends of the capillaries 111 again to clean the tip portions, and removes the excess sample attached to the outer walls of the capillaries 111 (S213). Thereafter, the buffer tray 122 is installed at the sample introduction ends of the capillaries 111 (S214).

After the sample injection, separation of the injected sample by electrophoresis is performed. A voltage is applied across the capillaries 111 by the high-voltage power supply 103, and the injected sample is migrated (S215). During electrophoresis, the temperature adjustment device 106 keeps the capillaries 111 at a constant temperature. A phosphor is applied to the sample, and fluorescence measurement is performed by the above-described method when the sample passes through the detection site 116. The moving speed of each component in the sample varies depending on the charge amount and the molecular size, and a difference is generated in the time to reach the detection site 116. Therefore, the time waveform of the fluorescence signal fluorescent at the detection site 116 gives information on the component of each sample. After the acquisition of the signal waveform is completed, the voltage application is terminated, and the measurement is terminated (S216).

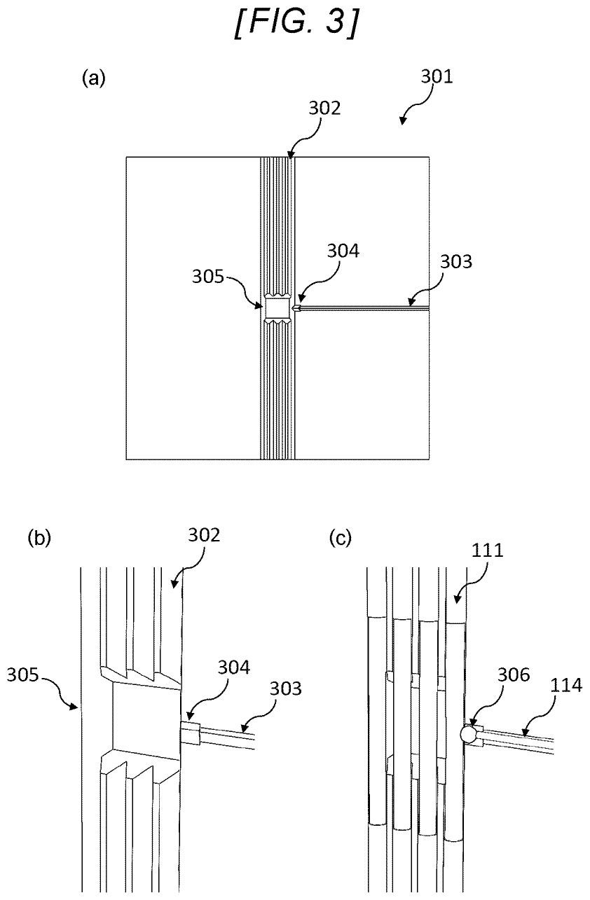

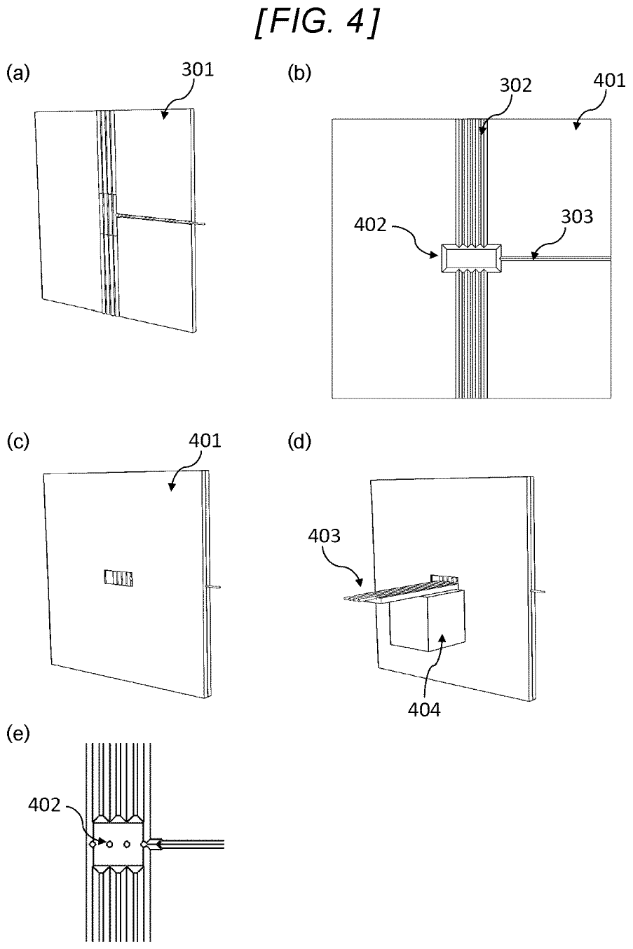

FIGS. 3 and 4 illustrate details of a structural example of the detection site 116. As an example, the detection site 116 can be formed by fixing the capillaries 111, the cartridge-side irradiation fiber 114, and the cartridge-side detection fibers 115 on the substrate having the V-shaped grooves. FIG. 3 (a) illustrates a structure of a fixing substrate 301 for fixing the capillaries 111 and the cartridge-side irradiation fiber 114. The fixing substrate 301 includes capillary fixing grooves 302 and a fiber fixing groove 303.

FIG. 3 (b) is an enlarged view of the vicinity of an intersection of the capillary fixing grooves 302 and the fiber fixing groove 303. The fiber fixing groove 303 has a lens fixing groove 304 immediately before an intersection with the capillary fixing grooves 302. A through hole 305 is provided at an intersection portion between the fiber fixing groove 303 and the capillary fixing grooves 302. The through hole 305 is provided so that the laser light emitted from the cartridge-side irradiation fiber 114 fixed to the fiber fixing groove 303 is not blocked by the wall surface of the capillary fixing grooves 302. In this example, the through hole 305 penetrates the substrate, but may be a recess that does not penetrate the substrate. The substrate having the shape of FIG. 3 (a) can be formed by anisotropic etching of silicon, for example.

FIG. 3 (c) is a diagram in a case where the capillaries 111, the cartridge-side irradiation fiber 114, and a ball lens 306 are installed on the fixing substrate 301. The capillaries 111 are generally coated with a coating such as polyimide, and this coating interferes with optical measurement around the through hole 305 and is thus removed. The excitation light guided by the cartridge-side irradiation fiber 114 is collimated by the ball lens 306. The collimated excitation light passes through the four capillaries 111 and excites the phosphor inside the capillaries 111. In the case of the optical configuration in the form of FIG. 3 (c), it is known that the outer diameters, the inner diameters, and the interval of the capillaries 111 may be set so that the excitation light sequentially propagates through each capillary due to the lens effect of the capillaries.

In general, the outer diameters of the capillaries 111, the cartridge-side irradiation fiber 114, and the ball lens 306 are different from each other. By adjusting the depth of each of the V-shaped grooves for fixing each of the capillaries 111, the cartridge-side irradiation fiber 114, and the ball lens 306 so that the central axis of each element coincides with the substrate front surface, it is possible to perform axial alignment of each element. Here, the ball lens 306 is used for collimating the excitation light emitted from the cartridge-side irradiation fiber 114. Alternatively, collimation may be performed by another method such as a GRIN lens or a lensed fiber. When the number of capillaries is one, there is an option of not performing collimation.

FIG. 4 illustrates a method of further attaching the cartridge-side detection fibers 115 to the fixing substrate 301 illustrated in FIG. 3 on which the capillaries 111 and the cartridge-side irradiation fiber 114 are fixed. A holding substrate 401 (FIG. 4 (b) ) having a structure similar to that of the fixing substrate 301 is attached to the fixing substrate 301 (FIG. 4 (a) ) on which the respective components have been installed. Like the fixing substrate 301, the holding substrate 401 has the capillary fixing grooves 302 and the fiber fixing groove 303. On the other hand, the structure of the holding substrate 401 is different from that of the fixing substrate 301 in that the detection fiber array attaching hole 402 is provided. The fixing substrate 301 and the holding substrate 401 are fixed such that the grooves face each other (FIG. 4 (c)).

As an example, the capillary fixing grooves 302 and the fiber fixing groove 303 of the holding substrate 401 are grooves in which the central axes thereof are located on the substrate front surface when the capillaries 111 and the cartridge-side irradiation fiber 114 are installed similarly to the structure of the fixing substrate 301. In this structure, the capillaries 111 and the cartridge-side irradiation fiber 114 are fixed by being sandwiched between the fixing substrate 301 and the holding substrate 401. In the example of FIG. 4, since the ball lens 306 is in contact with only the fixing substrate 301, it is necessary to fix it with an adhesive or the like. It is possible to adopt a structure in which the ball lens 306 is fixed to the cartridge-side irradiation fiber 114 in advance by adhesion with a transparent adhesive, or the ball lens 306 is installed at a position sandwiched by the substrates by separating the distance between the ball lens 306 and the capillaries 111.

As an example, the cartridge-side detection fibers 115 are fixed to V-shaped grooves formed in another substrate, thereby a detection fiber array 403 is formed. The detection fiber array 403 is fixed in a state of being inserted into the detection fiber array attaching hole 402 (FIG. 4 (d)). For example, an array fixing member 404 may be pressed and fixed to the holding substrate 401 with an adhesive or the like, and the detection fiber array 403 may be fixed to the array fixing member 404 with an adhesive or the like.

Alignment of the fiber array 403 and the capillaries 111 can be performed by a plurality of means. As an example, the size of the fiber array 403 and the size of the detection fiber array attaching hole 402 are adjusted to match each other, and when the fiber array 403 is fitted, the cartridge-side detection fibers 115 may be adjusted to be fixed so as to face the excitation light irradiation sites on the capillaries 111. Alternatively, the detection fiber array attaching holes 402 are holes corresponding to the number of capillaries formed at the position of the central axis of each capillary (FIG. 4 (e)), and the cartridge-side detection fibers 115 may be aligned by being inserted into these holes.

The alignment of the fiber array 403 may be performed using some observation means. As an example, the capillaries 111 and the fiber array 403 may be observed through the through hole 305 with a camera, and the fiber array 403 may be fixed in a state where the capillary and the fiber array are aligned. Alternatively, water, an aqueous solution of a fluorescent dye, or the like is injected into the capillaries 111, and a Raman signal, a fluorescence signal, or the like output from the cartridge-side detection fibers 115 in a state of being irradiated with excitation light is monitored. The position of the fiber array 403 may be adjusted and fixed such that these signals are maximized.

In FIGS. 3 and 4, an example in which the number of capillaries is four is illustrated, but any number of capillaries can be used. When the number of capillaries is large, two cartridge-side detection fibers 115 may be provided in order to equalize the power of the excitation light applied to each capillary, and the excitation light may be applied from both side surfaces of the capillary array.

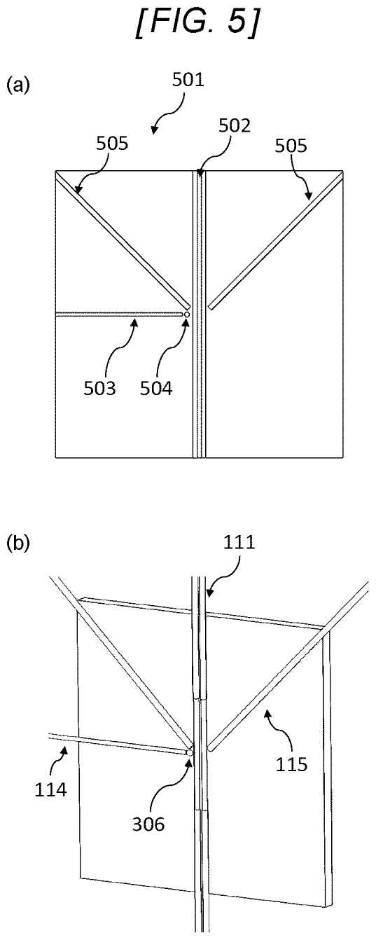

When the number of capillaries is 2 or less, the capillaries 111, the cartridge-side irradiation fiber 114, and the cartridge-side detection fibers 115 can be installed on the same substrate. FIG. 5 (a) illustrates a structural example of a fixing substrate 501 in a case where the number of capillaries is two. In this example, the fixing substrate 501 includes capillary fixing grooves 502, an irradiation fiber fixing groove 503, a ball lens fixing hole 504, and detection fiber fixing grooves 505. These grooves are formed by, for example, dry-etching a silicon substrate for forming grooves having a quadrangular cross section. When the grooves are a quadrangle, the depths or widths of the grooves are adjusted such that the central axes of the capillaries 111, the cartridge-side irradiation fiber 114, the ball lens 306, and the cartridge-side detection fibers 115 are on the same plane.

FIG. 5 (b) is a diagram in which the capillaries 111, the cartridge-side irradiation fiber 114, the ball lens 306, and the cartridge-side detection fibers 115 are installed on the fixing substrate 501. Each element is aligned by a groove and then fixed by an adhesive or the like. As in the example of FIG. 3, the coating of the capillaries 111 are removed at the detection positions.

The structure of the detection site 116 is not limited to the above-described configuration, and other configurations may be adopted as long as the relative positions the capillaries 111, the cartridge-side irradiation fiber 114, and the cartridge-side detection fibers 115 can be fixed. It is not always necessary to perform alignment by the structure and the groove on the substrate. For example, a method of adjusting the positions of the capillaries or the fibers by a jig or the like on the substrate and fixing the capillaries or the fibers with an adhesive may be used.

The cartridge-side irradiation fiber 114 and the cartridge-side detection fibers 115 are not necessarily arranged such that the central axes thereof face the detection points on the capillaries 111. For the cartridge-side irradiation fiber 114 and the cartridge-side detection fibers 115 whose central axes do not face the detection points on the capillaries 111, light emitted from the cartridge-side irradiation fiber 114 may be guided to the detection points on the capillaries 111 by a reflecting mirror provided on the fixing substrate 501, and fluorescence emitted from the detection points on the capillaries 111 may be incident on the cartridge-side detection fibers 115.

The requirement regarding the optical fiber arrangement is similar even when an element other than the reflecting mirror is present on the fixing substrate 501. It is assumed that a light beam emitted from the optical fiber end surface in the direction of the center axis of the optical fiber is emitted, and an optical element on the fixing substrate 501 exerts an optical effect such as reflection, refraction, or diffraction on the light beam. At this time, the trajectory of the light beam is defined as the optical axis of the optical fiber. In order to detect the fluorescences emitted from the substances in the capillaries, the optical axes Of the cartridge-side irradiation fiber 114 and the cartridge-side detection fibers 115 may intersect in the lumens of the capillaries 111. Note that the optical axes do not need to strictly intersect each other in the lumens of the capillaries 111, and an error is allowed if the optical axes are within a range in which fluorescences are incident on the cartridge-side detection fibers 115.

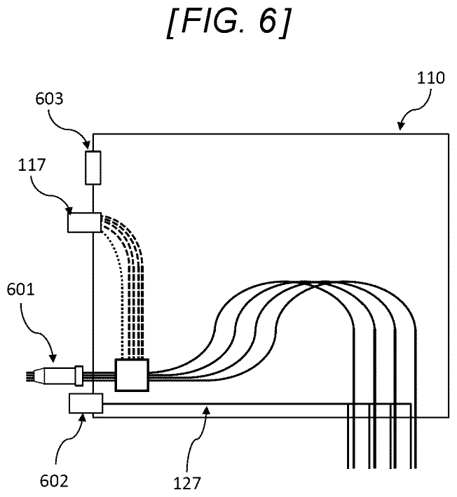

FIG. 6 is a diagram for describing connection in a case where the capillary cartridge 110 is installed in the electrophoresis device 100. The capillary array needs to be connected to the pump unit 105 in order to inject the polymer therein and to electrically connect with the electrodes in the buffer tank 107. As an example, the capillaries 111 are bundled at a connection portion and connected to the pump unit 105 using a fitting 601 or the like.

When an electrode 127 is incorporated in the capillary cartridge 110, the high-voltage power supply 103 and the electrode 127 are connected by an electrical connector 602. The temperature adjustment device 106 is connected via a temperature adjustment connector 603. When temperature adjustment is performed by a heater or the like incorporated in the capillary cartridge 110, the temperature adjustment connector 603 is an electrical connector. When temperature adjustment is performed by flowing a fluid such as air, the temperature adjustment connector 603 is a connection connector of a channel.

As described above, the body-side irradiation fiber 112 and the cartridge-side irradiation fiber 114, and the body-side detection fibers 113 and the cartridge-side detection fibers 115 are connected by the fiber connector 117. As the fiber connector 117, a commonly used SC connector, FC connector, LC connector, or the like can be used. When the number of fibers to be connected is large, a multi-fiber connector such as an MPO connector may be used. Alternatively, a specifically designed fiber connector may be used.

By adopting a structure in which the optical system of the electrophoresis device 100 and the capillary cartridge 110 is connected by connecting the body-side irradiation fiber 112 and the cartridge-side irradiation fiber 114 and connecting the body-side detection fibers 113 and the cartridge-side detection fibers 115, it is possible to achieve both ease of replacement of the capillary cartridge 110 and resistance to vibration and external environmental changes. The user can attach and detach the fiber cartridge 110 only by attaching and detaching the fiber connector 117 with respect to the optical system. Since transmission of light is performed by optical fibers, it is robust against the influence of vibration and external environmental changes.

For example, when a capillary 10 cm ahead of the light source is irradiated with excitation light with positional accuracy of +10 μm by beam propagation in a free space, angular variation of the beam is only allowed to be about ±0.01 or less. In order to realize this accuracy and stability, it is necessary to form the holding structure of the optical system with a strong material that is not deformed by vibration or impact and has small thermal expansion. As a result, the device becomes large and heavy. On the other hand, when transmission is performed by optical fibers, rigidity of a portion from the light source to the fiber and a portion from the fiber to the capillary may be kept high. Since the distance between these two components can be set to about several mm or less, the tolerance for the beam angle change due to the deformation of the holding structure also increases.

The above-described effects relate to a general optical fiber optical system. In particular, in the structure of the present disclosure, the capillaries 111, the cartridge-side irradiation fiber 114, and the cartridge-side detection fibers 115 are fixed on the substrate, and a connection point with the outside is separately provided, so that it is easy to achieve both easy attachment and detachment and fixing accuracy in connection between the electrophoresis device 100 and the capillary cartridge 110. In the case of the type in which the fiber array is attached to and detached from the capillary array as in PTL 2, the fixing structure of the fiber array needs to achieve both easy attachment and detachment and fixing accuracy, and there is a concern that the attaching and detaching mechanism is complicated and the cost is high. On the other hand, in the structure of the present disclosure, both the ease of attachment to and detachment from the external connection and the fixing accuracy are secured by the fiber connector, which is a component that has been widely used in general, and it is sufficient to satisfy the requirement of the fixing accuracy between the capillary and the fiber, so that it is possible to avoid complication and cost increase of the attaching and detaching mechanism.

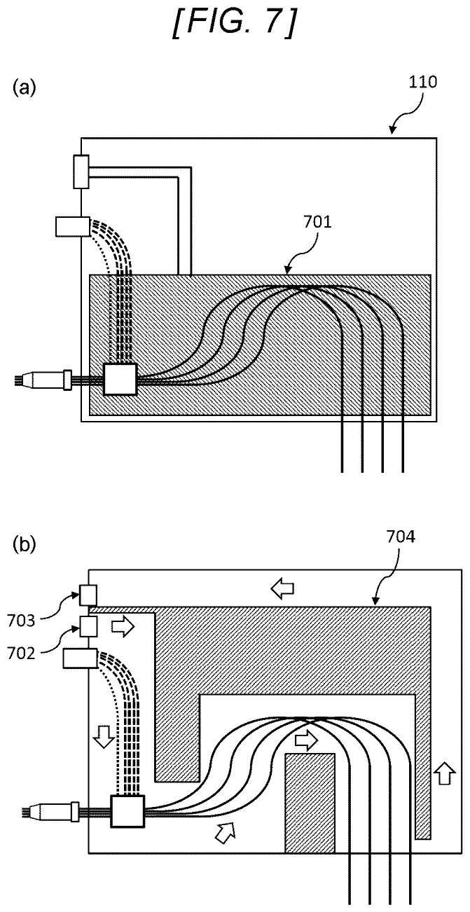

FIG. 7 Illustrates a Method of Adjusting the

temperature of the capillaries 111 in the capillary cartridge 110 of the present disclosure. FIG. 7 (a) illustrates an example in which the capillaries 111 is temperature-adjusted by a heating element such as a sheet heater 701. The capillaries 111 and the detection site 116 are disposed so as to be in contact with the sheet heater 701. The sheet heater 701 receives power supply from the electrophoresis device 100 via the temperature adjustment connector 603. The sheet heater 701 may be provided with a temperature sensor for feedback control.

FIG. 7 (b) illustrates an example in which the temperature of the capillaries 111 is adjusted by supplying a fluid such as temperature-adjusted air or inert liquid to the cartridge. In this example, the temperature adjustment connector 603 includes a fluid supply port 702 and a fluid discharge port 703. The temperature-adjusted fluid is supplied from the fluid supply port 702. A partition wall 704 is provided inside the cartridge, and the fluid flows without staying inside and adjusts the temperature of the capillaries 111. The fluid then returns from the fluid discharge port 703 to the electrophoresis device 100.

In a case where a liquid is used as the fluid for temperature adjustment, since the refractive index of the liquid is different from that of air, the liquid enters the detection site 116, so that the optical adjustment state may change. In this case, a structure in which the detection site 116 is sealed and the liquid does not enter the inside may be adopted. Alternatively, a structure in which the liquid enters the detection site 116 may be adopted, and optical design may be made assuming that measurement is performed in a state where the light passing site is filled with the liquid.

According to the configuration of the present disclosure, most of the capillaries including the detection site 116 can be temperature-regulated integrally. In the separation of the sample by electrophoresis, the mobility of the sample changes depending on the temperature of the separation medium, and thus it is desirable to minimize the temperature distribution of the capillaries and the temporal temperature fluctuation in order to obtain a stable measurement result. It is desirable that the temperature of the capillaries be kept constant not only when the device is under a certain environment but also when the air temperature around the device changes.

However, the conventional capillary electrophoresis device has a problem that the spatial distribution and temporal fluctuation of the temperature are likely to occur in the detection site 116 as compared with other sites of the capillaries. In order to perform fluorescence measurement at the detection site 116, it is necessary to irradiate the capillaries 111 with excitation light and guide the generated fluorescences to the detector. In order to realize fluorescence measurement by propagating light in a free space, it is necessary to provide an opening through which excitation light and fluorescences pass, and a temperature adjustment mechanism cannot be provided in this opening portion. In addition, since the capillary array needs to be fixed to the optical measurement mechanism inside the device, heat conduction occurs through the fixing portion, and the temperature changes.

For example, with respect to the spatial distribution and temporal variation of the temperature due to the influence of the opening, it is possible to take measures such as providing a transparent window having a high heat insulating property in the opening or providing an individual temperature adjustment mechanism in the opening. However, installation of a transparent window may cause deterioration in optical performance due to reflection by the window or the like, and non-uniformity of thermal conduction due to a difference between a material and a structure of the window and a surrounding material and structure still exists. In a countermeasure for providing the individual temperature adjustment mechanism in the opening portion, heating and cooling are performed in consideration of the thermal conduction state in the vicinity of the opening, but a structure and control for keeping the temperature uniform with other portions may be complicated. Since there is no change in the fact that the opening portion frequently exchanges heat with the outside with respect to other portions, there remains a problem that the capillary temperature is likely to change due to a temperature change of the external environment.

On the other hand, in the structure of the present disclosure, since the excitation light and the fluorescence are exchanged via the optical fiber, the measurement window portion can be almost completely isolated from the outside. In addition, when the temperature of the entire capillaries 111 including the detection site 116 is adjusted by the method illustrated in FIG. 7 or the like, it is possible to uniformly and integrally adjust the temperature of all the sites excluding the sample injection ends of the capillaries and the connection portions with the pump unit 105 that are structurally forced to be in contact with the outside. In addition, it is not necessary to provide a special mechanism for temperature adjustment, and stable temperature adjustment can be easily performed.

Further, since the positions of the capillaries 111, the cartridge-side irradiation fiber 114, and the cartridge-side detection fibers 115 are fixed inside the detection site 116, the entire capillaries 111 including the detection site 116 does not need to be firmly fixed to the cartridge 110 or the electrophoresis device 100. Therefore, it is possible to install a heater or a heat insulating material around the entire capillaries 111 including the detection site 116, which fixes the detection site 116 so as not to be in contact with the housing of the capillary cartridge 110 as much as possible in order to reduce heat transfer with the peripheral portion.

As a result, it is possible to control the entire capillaries 111 to a uniform temperature without providing an individual heat insulating mechanism or a temperature control mechanism in the measurement window portion. It is also possible to reduce the heat transfer path with the outside and more stably separate the sample by electrophoresis even if the temperature outside the device changes.

### First Embodiment: Summary

The electrophoresis device 100 according to the first embodiment includes the irradiation optical system 101, the body-side irradiation fiber 112, the detection optical system 102, and the body-side detection fibers 113. The capillary cartridge 110 includes the cartridge-side irradiation fiber 114 and the cartridge-side detection fibers 115. The relative positions of the capillaries 111, the cartridge-side irradiation fiber 114, and the cartridge-side detection fibers 115 are adjusted and fixed at the detection site 116. The body-side irradiation fiber 112 and the cartridge-side irradiation fiber 114, and the body-side detection fibers 113 and the cartridge-side detection fibers 115 are connected by the fiber connector 117. With the above configuration, it is possible to achieve both robustness against vibration and external environmental changes and ease of capillary replacement. In addition, by integrally adjusting the temperature of the entire capillaries 111 including the detection site 116, the temperature distribution of the capillaries can be made uniform, and the temperature fluctuation can be reduced.

### Second Embodiment

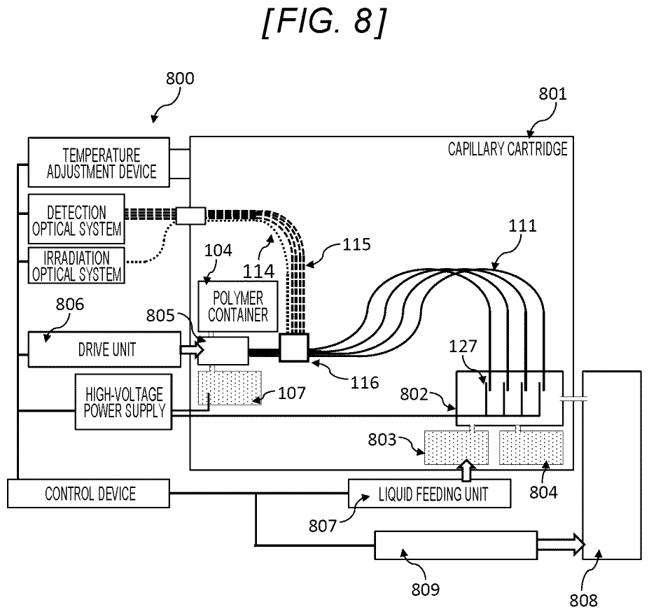

FIG. 8 is a configuration diagram of an electrophoresis device 800 according to a second embodiment of the present disclosure. The components of the electrophoresis device 800 according to the second embodiment are similar to those of the electrophoresis device 100 according to the first embodiment. However, the second embodiment is different from the first embodiment in that consumable items such as a polymer, a buffer, and a cleaning liquid and a channel structure for flowing these are integrated with the capillary cartridge 801. As in the first embodiment, the capillary cartridge includes capillaries 111, a cartridge-side irradiation fiber 114, cartridge-side detection fibers 115, and a detection site 116 therein. A sample injection-side channel 802 is provided at the sample injection ends of the capillaries 111. A solution tank 803 and a waste liquid tank 804 are connected to the sample injection-side channel 802. An electrode 127 is installed in the sample injection-side channel 802. The solution tank stores a buffer, a cleaning liquid, and the like. The opposite ends of the capillaries 111 are connected to a polymer injection channel 805. A polymer container 104 and a buffer container 107 are connected to the polymer injection channel 805. With this configuration, the maintenance work performed by the user is concentrated on the replacement of the capillary cartridge 801, and the time and effort for maintenance can be reduced as compared with the configuration of the first embodiment.

In the second embodiment, an operation similar to the operation of the first embodiment (FIG. 2) is performed by flowing each liquid in the channel. The polymer injection channel 805 has a structure similar to that of the pump unit 105, and performs polymer injection into the capillaries 111 (S202 to S206). In the present embodiment, a drive unit 806 that drives a mechanism corresponding to the syringe 119 is provided on the electrophoresis device 800 side.

Cleaning (S207, S210, S213) of the capillaries and electrical connection (S208, S214) between the capillary tips and the electrode by buffer injection are performed by feeding a cleaning liquid and a buffer from the solution tank to the sample injection-side channel 802. Each solution may be stored in a syringe, and the solution may be fed by pushing the syringe, or a mechanism for feeding the solution may be separately incorporated. As in the structure for injecting a polymer, a liquid feeding unit 807 for supplying power for feeding liquid is provided on the electrophoresis device 800 side. The waste liquid is discarded to the waste liquid tank 804.

The sample injection (S212) is performed by externally injecting the sample into the sample injection-side channel 802. The sample is held in a sample cartridge 808, and the sample is injected into the sample injection-side channel 802 by a sample cartridge control unit 809. Note that the sample cartridge 808 may simply temporarily hold the sample introduced by the user and feed the sample to the sample injection-side channel 802 at the timing of sample injection (S212), or may perform pretreatment such as purification of the sample or mixing with a reagent in addition to feeding. In a case where the sample cartridge 808 also performs preprocessing, the sample cartridge control unit 809 generally controls liquid feeding, mixing, and the like of various necessary reagents. For example, PTL 3 discloses a device that consistently performs from sample pretreatment to analysis by capillary electrophoresis and its structure.

In the electrophoresis device 800 according to the second embodiment, consumable items are incorporated in the capillary cartridge 801. Therefore, it is not possible to individually replace each consumable item such as a capillary, a polymer, and a buffer according to a consumption state. On the other hand, ease of maintenance of the device including replacement of consumable items is emphasized. Such a configuration is particularly suitable for use by a user who is not proficient in handling the device. Therefore, it is expected that the replacement of the capillary cartridge 801 can be easily performed without requiring a special operation.

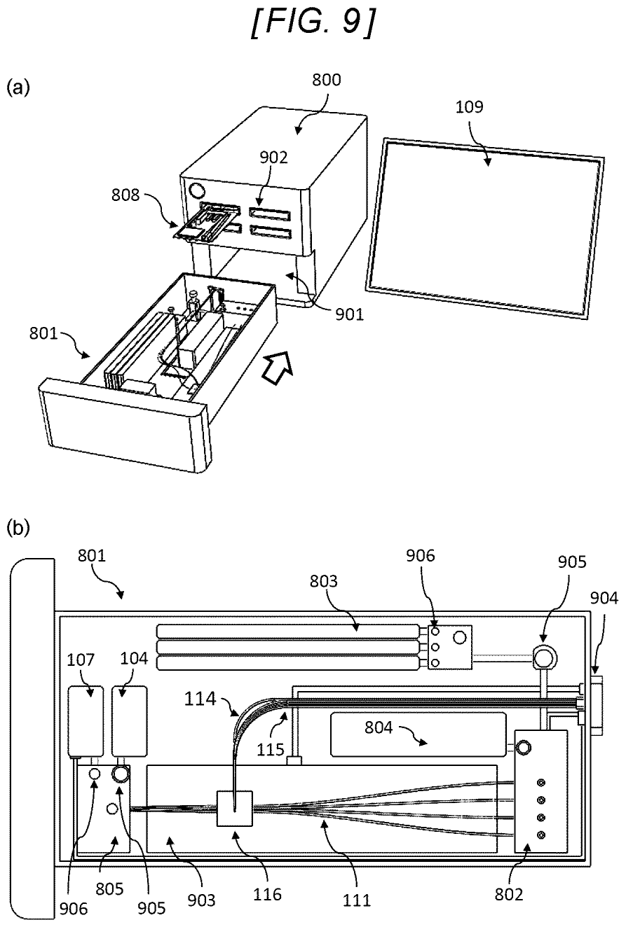

FIG. 9 illustrates an example of a structure in which the capillary cartridge 801 is installed in the electrophoresis device 800 according to the second embodiment. FIG. 9 (a) illustrates the electrophoresis device 800, the capillary cartridge 801, the sample cartridge 808, and the control device 109. In this structure, the capillary cartridge 801 is connected to be inserted into a capillary cartridge insertion portion 901 provided in the electrophoresis device 800. The sample cartridge 808 is connected to be inserted into a sample cartridge insertion portion 902 provided in the electrophoresis device 800. Although only the screen is illustrated, the control device 109 in FIG. 9 (a) may be a tablet PC, a notebook PC, a desktop PC, or the like, or may be integrally incorporated into the electrophoresis device 800.

FIG. 9 (b) illustrates an example of the structure of the capillary cartridge 801. The function and operation of each component are as described above. In this example, the temperature adjustment of the capillaries is performed by a heater 903. In FIG. 9 (b), the heater 903 is installed under the capillaries 111. Alternatively, the heater 903 may be arranged so as to sandwich the capillaries 111 in order to improve the temperature adjustment accuracy, or a heat insulating material may be installed on the upper surfaces of the capillaries 111.

In the example of FIG. 9 (b), electrical and optical connections are made by a connector 904. An electrical connector and an optical connector are incorporated in the connector 904. When the temperature of the capillaries is adjusted by circulation of the fluid, a connector for connecting the channel is provided. The supply of the external force from the drive unit 806 and the liquid feeding unit 807 is performed, for example, by applying a force to a liquid feeding mechanism 905 from above the cartridge by a mechanical mechanism provided in the electrophoresis device 800. As an example, the liquid feeding mechanism 905 has a syringe-like structure, and performs liquid feeding by being moved up and down by the electrophoresis device 800. A valve 906 is also opened and closed by a mechanical force from the electrophoresis device 800. Note that these mechanical forces are not limited to vertical movement, and rotational force or the like may be applied. It is not excluded that a component that generates a mechanical force, such as a motor or a solenoid, is installed inside the capillary cartridge 801.

With the structure illustrated in FIG. 9, the user can easily attach and detach the sample cartridge 801 to and from the electrophoresis device 800. When the sample cartridge 801 is inserted deep into the capillary cartridge insertion portion 901 of the electrophoresis device 800, the sample cartridge 801 and the electrophoresis device 800 are electrically and optically connected by the connector 904. A mechanism for inserting mechanical force into the liquid feeding mechanism 905, the valve 906, and the like is accessed from the upper portion of the sample cartridge 801. The mechanical mechanism is installed so as not to interfere when the sample cartridge 801 is attached or detached, or is moved to a position where the mechanical mechanism does not interfere when the sample cartridge 801 is attached or detached. The sample cartridge 801 is a consumable item, and needs to be newly replaced with a new sample cartridge 801 after a certain number of times of use. Therefore, there is an advantage in that the sample cartridge 801 can be easily attached and detached. By the optical connection using the optical fiber and the optical connector, the optical unit becomes robust against vibration and a change in the external environment as described above.

When attached to the electrophoresis device 800, the sample cartridge 801 is mechanically fixed to the electrophoresis device 800 so as not to fall off. The fixing mechanism is provided in a housing portion of the sample cartridge 801. On the other hand, a commercially available optical connector generally incorporates a fixing mechanism for fixing to an adapter. The fixing mechanism of the sample cartridge 801 and the fixing mechanism of the optical connector may be simultaneously fixed when attached to the electrophoresis device 800. Alternatively, the fixing mechanism may not be incorporated in the optical connector, and the fixing may be performed only by the fixing mechanism of the sample cartridge 801.

As described above, the optical system of the electrophoresis device 800 of the present disclosure is robust against vibration and external environmental changes by using the optical fiber and the optical connector. However, when a strong impact is applied to the device, the position of the optical component may change, and the component may be damaged. As protection against a strong impact, there is a method of attaching a cushioning material to an object to be protected. In the configuration in which the light beam is propagated in the free space, relative positions of the excitation light irradiation optical system, the capillaries, and the detection optical system need to be fixed. Therefore, for example, it is conceivable that the excitation light irradiation optical system, the capillaries, and the detection optical system are attached to the same structural support, and the above-described structural support is protected by the cushioning material. In this case, the protection target includes a light source, a detection system, a structural support, and the like, and has a corresponding weight. It is necessary to install an interference mechanism that supports this weight and has sufficient cushioning performance.

On the other hand, in the structure of the present disclosure, the irradiation optical system 101, the detection optical system 102, and the detection site 116 are connected by an optical fiber. Since the optical fiber has a flexible property, the irradiation optical system 101, the detection optical system 102, and the detection site 116 can be individually protected with the cushioning material. In particular, the detection site 116 includes the capillaries 111 from which the coating has been removed, the cartridge-side irradiation fiber 114, and the cartridge-side detection fibers 115, and the position accuracy between these three components is important for the measurement performance, and thus, protection against impact is particularly required.

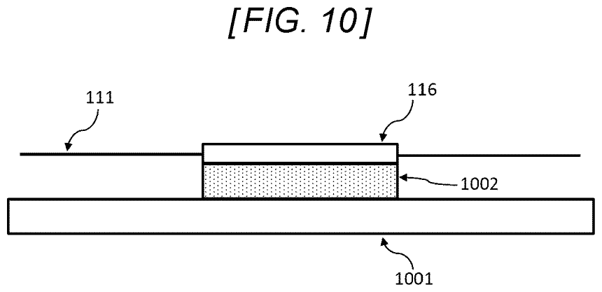

As illustrated in FIG. 10, the detection site 116 can be fixed to a structural support 1001 such as the inner wall of the capillary cartridge 801 via a cushioning material 1002. The detection site 116 is lightweight including only lightweight members such as the capillaries 111, the cartridge-side irradiation fiber 114, and the cartridge-side detection fibers 115. Therefore, sufficient cushioning performance can be obtained with a simple configuration in which a soft member such as rubber is simply adopted as the cushioning material 1002, and the structural support 1001, the cushioning material 1002, and the detection site 116 are bonded and fixed.

In the configuration disclosed in PTL 2, a detection fiber array is connected to a capillary array included in a capillary cartridge. In this manner, even when the connection mechanism including the fiber is connected to the capillary inside the cartridge, it is possible to protect the cartridge and the connection mechanism from impact in an integrated state. However, the configuration of the present disclosure can reduce the weight of the detection site 116 as compared with the above structure. This is advantageous for protection against vibration and impact.

### Second Embodiment: Summary

The electrophoresis device 800 according to the second embodiment has components similar to those of the electrophoresis device 100 according to the first embodiment and performs similar operations, but is different in that consumable items such as polymers and buffers are installed inside the capillary cartridge 801. In addition to an optical connector, electrical and fluid connectors are installed in the capillary cartridge 801. When the capillary cartridge 801 is inserted into the electrophoresis device 800, both are connected by these connectors. Mechanical force is supplied from the electrophoresis device 800. The detection site 116 is fixed to the structural support 1001 via the cushioning material 1002.

### Third Embodiment

In the first and second embodiments, the detection of the sample in the capillary is performed by the fluorescence measurement. The configuration of the present disclosure also functions in a method other than the fluorescence detection. As an example, in a third embodiment, a case where a sample is detected by light absorbance measurement will be described. The structure and operation of an electrophoresis device in the third embodiment are the same as those in the first and second embodiments, and thus are omitted. The third embodiment is different from the first and second embodiments in the method of photodetection, and thus the structure of the detection site 116 is different.

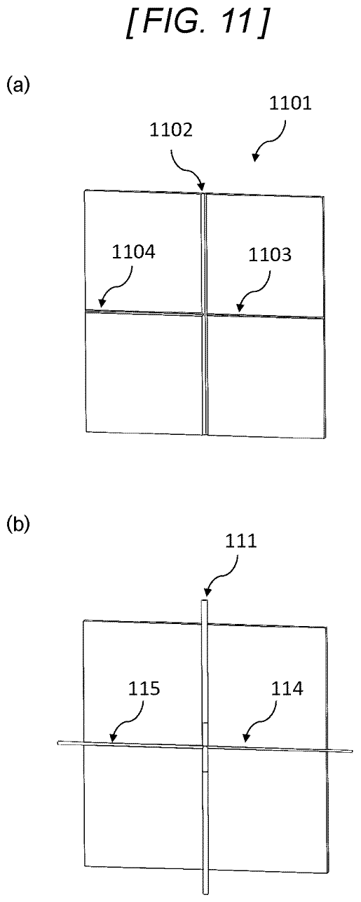

FIG. 11 illustrates details of the structure of the detection site 116 in the third embodiment. In the light absorbance measurement, it is necessary to irradiate the capillary 111 with light emitted from the cartridge-side irradiation fiber 114, causes the light to pass through the capillary 111, and then collect the light with the cartridge-side detection fiber 115. In the present embodiment, this is realized by having a structure in which the cartridge-side irradiation fiber 114 and the cartridge-side detection fiber 115 face each other with the capillary 111 interposed therebetween.

FIG. 11 (a) illustrates a structure of the fixing substrate 1101 for fixing the capillary 111, the cartridge-side irradiation fiber 114, and the cartridge-side detection fiber 115 on the substrate and taking the above-described configuration. The fixing substrate 1101 is provided with a capillary fixing groove 1102, an irradiation fiber fixing groove 1103, and a detection fiber fixing groove 1104. FIG. 11 (b) is a diagram in which the capillary 111, the cartridge-side irradiation fiber 114, and the cartridge-side detection fiber 115 are fixed on the fixing substrate 1101.

Note that, in the present embodiment, an optical element other than the optical fiber is not used. Alternatively, an optical element other than the optical fiber may be installed on the fixing substrate 1101 as necessary. When a plurality of capillaries is provided, a plurality of structures illustrated in FIG. 11 may be arranged in parallel, or a structure similar to FIGS. 3 and 4 may be taken and the irradiation fiber array and the detection fiber array may be arranged to sandwich the capillary array.

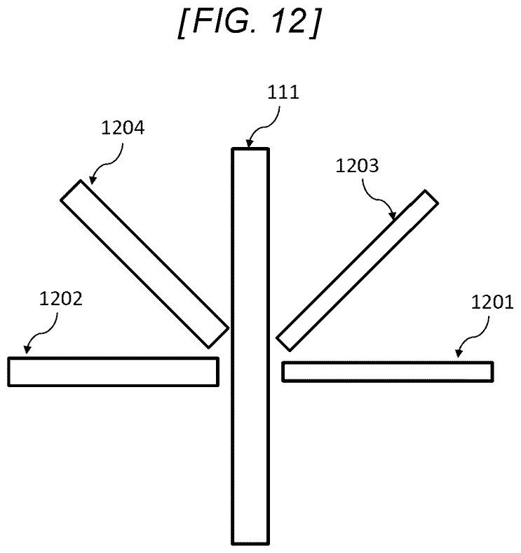

It is also possible to achieve both the configuration of light absorbance measurement and the configuration of fluorescence measurement. For example, as illustrated in FIG. 12, an absorbance measurement irradiation fiber 1201 and an absorbance measurement detection fiber 1202 may be installed for the capillary 111, and a fluorescence measurement irradiation fiber 1203 and a fluorescence measurement detection fiber 1204 may be arranged at an angle of 45 degrees with respect to the absorbance measurement irradiation fiber 1201 and the absorbance measurement detection fiber 1202.

### Third Embodiment: Summary

In the detection site 116 according to the third embodiment, the cartridge-side irradiation fiber 114 and the cartridge-side detection fiber 115 are fixed to face each other across the capillary 111. The light emitted from the cartridge-side irradiation fiber 114 passes through the capillary 111 and then is incident on the cartridge-side detection fiber 115, whereby the absorbance measurement is performed.

### Fourth Embodiment

In a fourth embodiment, with respect to a fixing substrate for fixing capillaries, an irradiation fiber, and a detection fiber, a method of forming a through hole by forming grooves on both a substrate front surface and a substrate back surface, and a structure of a substrate manufactured by this method will be described.

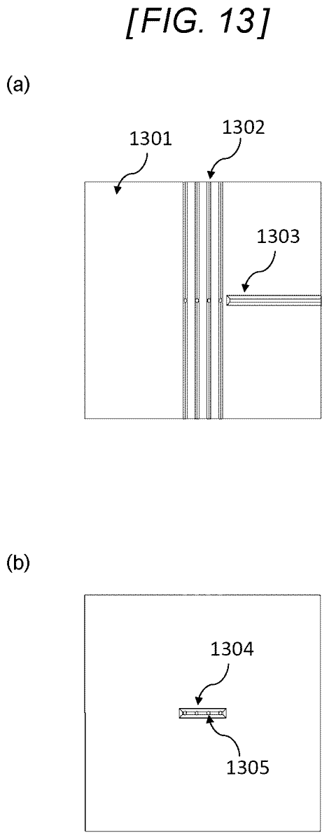

FIG. 13 illustrates a structure of a fixing substrate 1301 according to a fourth embodiment. FIG. 13 (a) illustrates the front surface of the fixing substrate 1301, and FIG. 13 (b) illustrates the back surface of the fixing substrate 1301. Similarly to the fixing substrate 301 according to the first embodiment, the fixing substrate 1301 fixes four capillaries, one irradiation fiber, and four detection fibers. Capillary fixing grooves 1302 for positioning four capillaries and an irradiation fiber fixing groove 1303 for positioning one irradiation fiber are provided on the front surface of the fixing substrate 1301. A through hole forming groove 1304 formed in a direction orthogonal to the capillary fixing groove 1302 is provided on the back surface. Through holes 1305 are formed at an intersection of the capillary fixing grooves 1302 and the through hole forming groove 1304. The four detection fibers are positioned by being inserted into the through holes 1305.

A method of positioning the capillaries, the irradiation fiber, and the detection fibers is similar to the method of positioning the capillaries, the irradiation fiber, and the detection fibers on the substrate described in FIG. 4 (e) of the first embodiment. However, the substrate illustrated in FIG. 4 (e) is different in that the capillary fixing grooves are formed and then the through holes are formed by another means, whereas the substrate of the present embodiment is different in that the fixing grooves and the through holes are simultaneously formed by forming the grooves on both the front surface and the back surface.

A method for forming the through hole will be described in detail below. The capillary fixing grooves 1302 and the through hole forming groove 1304 are each formed at a depth that does not penetrate the substrate (groove depth<substrate thickness). On the other hand, the sum of the depth of the capillary fixing groove 1302 and the depth of the through hole forming groove 1304 is set to be larger than the thickness of the substrate. At this time, the bottom of the capillary fixing grooves 1302 and the through hole forming groove 1304 overlap each other, and the overlapped portions becomes the through holes 1305 connected to the grooves and penetrating the substrate. By adopting this method, groove formation and through hole formation at positions along the grooves can be simultaneously performed.

In manufacturing the fixing substrate 1301, as an example, the substrate material may be silicon, and grooves having a V-shaped cross section may be formed by anisotropic etching of silicon. First, thermal oxide films are formed on the front surface and the back surface of a silicon substrate having 100 plane. Thereafter, a resist is applied, exposed, and developed, and then etched with hydrofluoric acid to remove the oxide film at the portion where the V grooves are formed. That is, the oxide film in the portions corresponding to the capillary fixing grooves 1302, the irradiation fiber fixing groove 1303, and the through hole forming groove 1304 is removed. Thereafter, the substrate is anisotropically etched with an alkali solution such as a potassium hydroxide aqueous solution to form V grooves. The capillary fixing grooves 1302, the irradiation fiber fixing groove 1303, and the through hole forming groove 1304 are formed by etching. When the etching progresses and the bottoms of the capillary fixing grooves 1302 and the bottom of the through hole forming groove 1304 cross each other, the through holes 1305 are formed. The sizes of the through holes can be adjusted by adjusting the width of the through hole forming groove 1304 and the etching time. After the V-shaped grooves are formed, the remaining oxide film is removed. The material of the mask used in the anisotropic etching, the solution used in the etching, and the like may be different from those described above.

In the case of a configuration in which laser light is emitted from the side surface of the capillary array in which the capillaries are arranged in a row to excite the phosphor in the capillary, the distances from the substrate front surface of the irradiation fiber and the capillaries need to be aligned with accuracy of about 10 μm or less. In the case of anisotropic etching of silicon, the widths and angles of the V grooves can be controlled with high accuracy, and the heights of the capillaries and the irradiated fiber from the substrate front surface can be aligned with high accuracy.

Note that the material of the substrate of the fourth embodiment is not necessarily silicon, and the method for forming the fixed grooves is not necessarily anisotropic etching. It is sufficient that grooves for fixing the capillaries, the irradiation fiber, and the detection fiber can be formed with sufficient accuracy, and it is sufficient that grooves having a depth enough to form through holes in the substrate can be formed by etching from the front surface and the back surface.

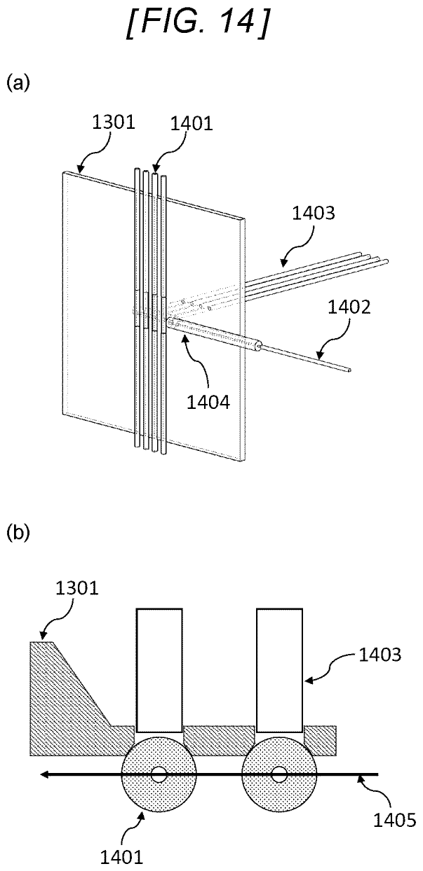

FIG. 14 (a) is a structural diagram when capillaries 1401, an irradiation fiber 1402, and detection fibers 1403 are attached to the fixing substrate 1301. FIG. 14 (b) is a cross-sectional view of the structure of FIG. 14 (a) taken along a plane perpendicular to the capillary fixing grooves 1302 at the position of the through holes.

The capillary 1401 is fixed by the capillary fixing groove 1302 such that the central axis of the capillary 1401 is located at a position away from the front surface of the fixing substrate 1301 by a certain distance. For example, the capillary 1401 may be fixed with an adhesive or the like in a state of being pressed against the capillary fixing groove 1302 by a capillary holding substrate (not illustrated).

In FIG. 14 (a), the irradiation fiber 1402 is fixed to the fixing substrate 1301 in a state of being inserted into a position adjustment component 1404. The position adjustment component 1404 is a cylindrical component, and a hole into which the irradiation fiber 1402 is inserted is provided at the center. A portion into which a lens for collimating the excitation light emitted from the irradiation fiber 1402 is inserted is provided at the end on the capillary side of the position adjustment component 1404. Optical axis adjustment of the irradiation fiber 1402 and the lens is performed by inserting a lens into this portion. As an example, a conical hole may be provided at the end of the position adjustment component 1404, and the end of the ball lens may be fixed with an adhesive or the like by fitting the ball lens into the conical hole. The distance between the irradiation fiber 1402 and the lens may be adjusted while confirming a spot shape of light formed by the lens while emitting light from the irradiation fiber 1402. When the number of the capillaries 1401 is one, the lens is not necessarily used. The lens is not necessarily fixed by the position adjustment component 1404, and a method of providing a recess for attaching the lens on the fixing substrate 1301 may be adopted.

The detection fibers 1403 are inserted into and fixed to the through holes 1305. At this time, the excitation light 1405 and the detection fibers 1403 are arranged orthogonal to each other as illustrated in FIG. 14 (b).

The fixing substrate of the fourth embodiment also has an effect of reducing crosstalk between capillaries when the number of capillaries is plural. When the number of capillaries is plural, fluorescence emitted from a certain capillary may enter an optical fiber for detecting different capillaries. In such a case, fluorescence of a certain capillary is erroneously recognized as light emitted by another capillary (crosstalk). When crosstalk is present, fluorescence caused by a component a of a sample A being analyzed in a certain capillary is erroneously identified as a signal from a capillary analyzing another sample B, which may lead to an erroneous analysis result that the component a is contained in the sample B.

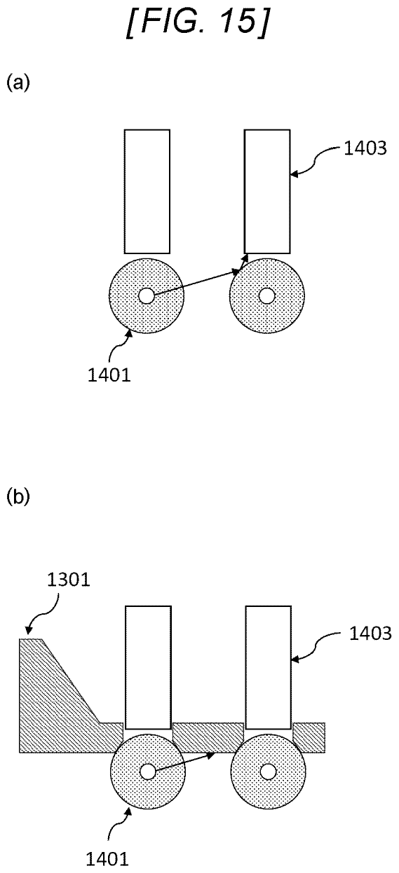

The crosstalk between the capillaries may occur, for example, in the path illustrated in FIG. 15 (a). In FIG. 15 (a), a fluorescent light beam (arrow) generated in the left capillary is reflected by the front surface of the right capillary and enters the detection fiber that detects a fluorescent light beam from the right capillary. The occurrence of crosstalk in the above path is suppressed by the structure of the fixing substrate of the fourth embodiment. In the fixing substrate of the fourth embodiment, a region other than the portion where the groove for fixing the capillary is formed is a wall separating the capillaries. As illustrated in FIG. 15 (b), the crosstalk occurrence path illustrated in FIG. 15 (a) is blocked by this wall.

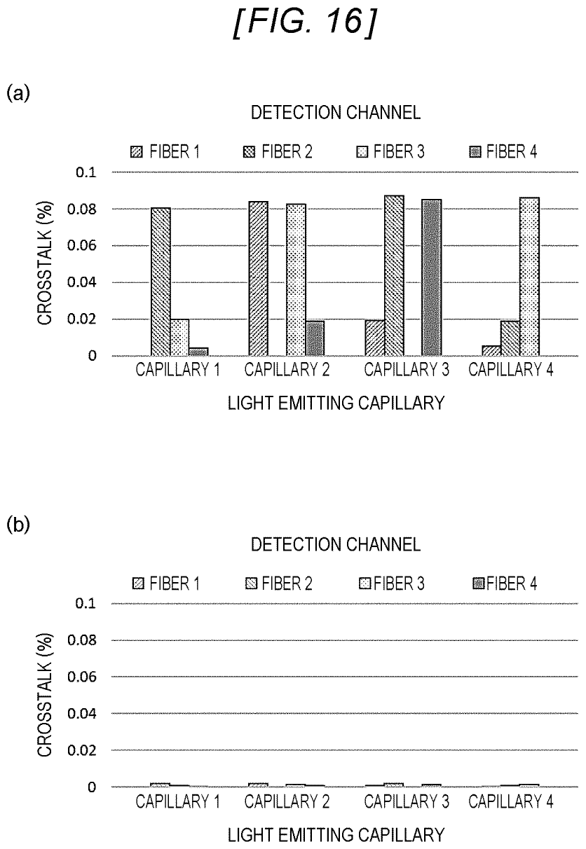

FIG. 16 is a result of a simulation illustrating the crosstalk suppression effect by the fixing substrate. In this simulation, four capillaries having an inner diameter of 50 μm and an outer diameter of 343 μm are arranged at an interval of 1 mm, and fluorescence is detected by optical fibers having a core diameter of 200 μm and an NA of 0.5. In this simulation, a region having a length of 50 μm in an inner diameter portion of one of the four capillaries is caused to emit light, and the ratio of fluorescence incident on the detection fibers for the other capillaries, that is, the ratio of crosstalk is calculated.

FIG. 16 (a) illustrates a value of crosstalk in a case where there is no fixing substrate. The horizontal axis of the graph represents a fiber emitting light, and each bar graph represents crosstalk observed in a fiber other than the fiber detecting the capillary emitting light. When there is no fixing substrate, crosstalk of about 0.08% is observed in an optical fiber that detects a capillary adjacent to a capillary emitting light. On the other hand, FIG. 16 (b) illustrates crosstalk in a case where there is a fixing substrate. In a case where there is the fixing substrate, it can be seen that the observed crosstalk is about 0.002%, and the ratio of the crosstalk is reduced to about 1/40.

### Fourth Embodiment: Summary

The fixing substrate 1301 according to the fourth embodiment has the capillary fixing grooves 1302 and the irradiation fiber fixing groove 1303 on the substrate front surface, and has the through hole forming groove 1304 on the back surface. The through holes 1305 are formed as an intersection of the capillary fixing grooves 1302 and the through hole forming groove 1304. A region where the capillary fixing grooves 1302 are not formed serves as a walls separating adjacent capillaries, and reduces crosstalk between the capillaries.

### Modifications

The present disclosure is not limited to the above-described embodiments, and includes various modifications. For example, the above-described embodiments have been described in detail in order to facilitate understanding of the present disclosure, and are not necessarily limited to those having all the described configurations. Further, a part of the configuration of one embodiment can be replaced with the configuration of another embodiment, and further, the configuration of one embodiment can be added to the configuration of another embodiment. In addition, it is possible to add, delete, and replace other configurations for a part of the configuration of each embodiment.

### REFERENCE SIGNS LIST

100 electrophoresis device
101 irradiation optical system
102 detection optical system
103 high-voltage power supply
104 polymer container
105 pump unit
106 temperature adjustment device
107 buffer container
108 autosampler unit
109 control device
110 capillary cartridge
111 capillary
112 body-side irradiation fiber
113 body-side detection fiber
114 cartridge-side irradiation fiber
115 cartridge-side detection fiber
116 detection site
117 fiber connector
118 channel block
119 syringe
120 check valve
121 valve
122 buffer tray
123 cleaning water tray
124 waste liquid tray
125 sample tray
126 stage
127 electrode
301 fixing substrate
302 capillary fixing groove
303 fiber fixing groove
304 lens fixing groove
305 through hole
306 ball lens
401 holding substrate
402 detection fiber array attaching hole
403 detection fiber array
404 array fixing member
501 fixing substrate
502 capillary fixing groove
503 irradiation fiber fixing groove
504 ball lens fixing hole
505 detection fiber fixing groove
601 fitting
602 electrical connector
603 temperature adjustment connector
701 sheet heater
702 fluid supply port
703 fluid discharge port
704 partition wall
800 electrophoresis device
801 capillary cartridge
802 sample injection-side channel
803 solution tank
804 waste liquid tank
805 polymer injection channel
806 drive unit
807 liquid feeding unit
808 sample cartridge
809 sample cartridge control unit
901 capillary cartridge insertion portion
902 sample cartridge insertion portion
903 heater
904 connector
905 liquid feeding mechanism
906 valve
1001 structural support
1002 cushioning material
1101 fixing substrate
1102 capillary fixing groove
1103 irradiation fiber fixing groove
1104 detection fiber fixing groove
1201 absorbance measurement irradiation fiber
1202 absorbance measurement detection fiber
1203 fluorescence measurement irradiation fiber
1204 fluorescence measurement detection fiber
1301 fixing substrate
1302 capillary fixing groove
1303 irradiation fiber fixing groove
1304 through hole forming groove
1305 through hole
1401 capillary
1402 irradiation fiber
1403 detection fiber
1404 position adjustment component
1405 excitation light

1. A capillary electrophoresis device comprising: a light source; a first irradiation fiber configured to guide light from the light source; a detector configured to detect light; and a first detection fiber configured to guide light to the detector,
wherein a capillary cartridge including a capillary, a second irradiation fiber, and a second detection fiber is attached to the electrophoresis device by connecting the first irradiation fiber and the second irradiation fiber and connecting the first detection fiber and the second detection fiber, and in the capillary cartridge, the second irradiation fiber and the second detection fiber are fixed such that optical axes of the second irradiation fiber and the second detection fiber intersect each other in an inner cavity of the capillary.

2. The capillary electrophoresis device according to claim 1, wherein a sample detection method is fluorescence measurement.

3. The capillary electrophoresis device according to claim 1, wherein a sample detection method is light absorbance measurement.

4. The capillary electrophoresis device according to claim 2, wherein
the capillary cartridge includes a plurality of the capillaries,
excitation light is incident, by the second irradiation fiber, on the capillaries arrange in a line on a substrate, the light being incident on a side surface of an array configured by the capillaries arranged in a line, and
fluorescence from each of the capillaries collected by a plurality of the second detection fibers is guided to a detector through the first detection fiber.

5. The capillary electrophoresis device according to claim 2, wherein in the capillary cartridge, a substrate to which the capillary and the second irradiation fiber are fixed and a substrate to which the second detection fiber is fixed are fixed so as to be substantially perpendicular to each other.

6. The capillary electrophoresis device according to claim 2, wherein
the capillary, the second irradiation fiber, and the second detection fiber are fixed to the same substrate so that the second detection fiber is substantially perpendicular to a plane formed by the capillary and the second irradiation fiber, and
alignment of the capillary, the second irradiation fiber, and the second detection fiber is achieved by grooves and a through hole formed on the substrate.

7. The capillary electrophoresis device according to claim 2, wherein
in the capillary cartridge, the capillary, the second irradiation fiber, and the second detection fiber are fixed on a substrate so as to be all in the same plane, and
adjustment of positions among the capillary, the second irradiation fiber, and the second detection fiber is performed by grooves formed on the substrate.

8. The capillary electrophoresis device according to claim 1, wherein the capillary is temperature-adjusted integrally with the second irradiation fiber, the second detection fiber, and a fixing member for fixing the second irradiation fiber, the second detection fiber, and the capillary.

9. The capillary electrophoresis device according to claim 1, wherein the capillary is installed in a housing, and is connected to the electrophoresis device via an optical connector installed on an outer wall of the housing.

10. The capillary electrophoresis device according to claim 9, wherein a portion fixed such that the optical axes of the second irradiation fiber and the second detection fiber intersect each other in the lumen of the capillary is fixed to the housing via a buffer structure.

11. A capillary cartridge comprising a capillary, a first irradiation fiber, and a first detection fiber, wherein
the first irradiation fiber and the first detection fiber are fixed such that optical axes of the first irradiation fiber and the first detection fiber intersect each other in a lumen of the capillary, and
the capillary cartridge is attached to an electrophoresis device including a light source, a second irradiation fiber configured to guide light from the light source, a detector configured to detect light, and a second detection fiber configured to guide light to the detector by connecting the first irradiation fiber and the second irradiation fiber, and connecting the first detection fiber and the second detection fiber.

12. The capillary cartridge according to claim 11, wherein, when the capillary cartridge is installed in the electrophoresis device, connection of the first irradiation fiber and the second irradiation fiber and connection of the first detection fiber and the second detection fiber are achieved by inserting the capillary cartridge into a site for insertion into the electrophoresis device.

13. The capillary electrophoresis device according to claim 6, wherein the substrate has, on a front surface, a groove for fixing the capillary and a groove for fixing the second irradiation fiber and has, on a back surface, a through hole forming groove orthogonal to the groove for fixing the capillary, and the second detection fiber is installed in a through hole formed at an intersection of the groove for fixing the capillary and the through hole forming groove.

14. (canceled)

15. The capillary cartridge according to claim 12, wherein the capillary, the second irradiation fiber, and the second detection fiber are fixed to a substrate, the substrate has, on a front surface, a groove for fixing the capillary and a groove for fixing the second irradiation fiber and has, on a back surface, a through hole forming groove orthogonal to the groove for fixing the capillary, and the second detection fiber is installed in a through hole formed at an intersection of the groove for fixing the capillary and the through hole forming groove.

16. A fixing substrate manufacturing method for manufacturing a fixing substrate, in a capillary cartridge connected to an electrophoresis device including a light source, the first irradiation fiber configured to guide light from the light source, a detector configured to detect light, and the first detection fiber configured to guide light to the detector, the fixing substrate being for fixing a capillary, a second irradiation fiber connected to a first irradiation fiber, and a second detection fiber connected to a first detection fiber, the method comprising
forming, on a front surface of the fixing substrate, a groove for fixing the capillary and a groove for fixing the second irradiation fiber, forming, on a back surface, a groove orthogonal to the groove for fixing the capillary, and forming a through hole for fixing the second detection fiber by crossing the groove for fixing the capillary and the orthogonal groove to each other.

17. The fixing substrate manufacturing method according to claim 16, wherein a material of the fixing substrate is silicon, and the groove for fixing the capillary, the groove for forming the irradiation fiber, and the groove orthogonal to the groove for fixing the capillary are formed by anisotropic etching.

18. The capillary electrophoresis device according to claim 4, wherein in the capillary cartridge, a substrate to which the capillaries and the second irradiation fiber are fixed and a substrate to which the second detection fibers are fixed are fixed so as to be substantially perpendicular to each other.

19. The capillary electrophoresis device according to claim 4, wherein
the capillaries, the second irradiation fiber, and the second detection fibers are fixed to the same substrate so that the second detection fibers are substantially perpendicular to a plane formed by the capillaries and the second irradiation fiber, and
alignment of the capillaries, the second irradiation fiber, and the second detection fibers is achieved by grooves and through holes formed on the substrate.

20. The capillary electrophoresis device according to claim 4, wherein
in the capillary cartridge, the capillaries, the second irradiation fiber, and the second detection fibers are fixed on a substrate so as to be all in the same plane, and
adjustment of positions among the capillaries, the second irradiation fiber, and the second detection fibers is performed by grooves formed on the substrate.

21. The capillary electrophoresis device according to claim 19, wherein the substrate has a structure for blocking light between the through holes.
